(19) United States
(12) Patent Application Publication
(10) Pub. No.: US 2004/0034600 A1
(43) Pub. Date: Feb. 19, 2004

(54) Contents distribution system, contents distribution apparatus, terminal, and method of distributing contents

(75) Inventors: Takanori Senoh, Osaka (JP); Takuyo Kogure, Osaka (JP); Terumasa Aoki, Saitama (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/449,067

(22) Filed: Jun. 2, 2003

(30) Foreign Application Priority Data
Jun. 3, 2002 (JP) 2002-161455

(51) Int. Cl. H04K 1/00

(52) U.S. Cl. 705/50

(57) ABSTRACT

The contents distribution apparatus has a conversion section 9, composite key generation section 8, and adder 10. The conversion section 9 converts contents C to generate converted contents C/Nc using a contents identification number Nc previously allocated to the contents. The composite key generation section 8 generates a composite key from the contents identification number Nc, a storage identification number Ns, and a terminal key α corresponding to the terminal. The adder 10 adds the composite key K generated by the composite key generation section 8 to the converted contents C/Nc generated by the conversion section 9 so as to generate added conversion contents C′.

### BACKGROUND OF THE INVENTION

1. Field of the Invention

The present invention relates to a contents distribution system in which digitized contents such as video, audio, and the like are distributed through a network and the like. Specifically, the present invention relates to a contents distribution system which achieves a secure communication distribution and prevention of illegal distribution of contents.

2. Description of the Related Art

FIG. 7 shows a conventional digital contents information distribution system. In FIG. 7, a reference numeral 51 denotes an input terminal, and a reference numeral 52 denotes an output terminal. Contents C are distributed from the input terminal 51 to the output terminal 52. In FIG. 7, a reference numeral 1 denotes a contents distribution apparatus, 2 denotes a communication network, 3 denotes a terminal, 4 denotes a storage, 50 denotes a key, and 5 denotes a contents identification number (ID number) providing mechanism. The contents C are distributed through a contents distribution path from the input terminal 51 to the terminal 52, and stored in the storage 4 as required. The contents distributor allocates a specific number (ID number) to the contents C according to the requirement of management of the contents C (e.g. distribution control and accounting). For this purpose, the contents ID number providing mechanism 5 is provided in this system.

The specific number is allocated to the contents C by the contents ID number providing mechanism 5 and used as the identification number (ID number) of the contents C during distribution. The contents C are not stored unconditionally in the storage device 4 depending on the conditions for distributing the contents C. Therefore, a system is required in which distribution conditions, such as permission of reading, non-permission of reading, or permission of transfer, are set at the time of distributing the contents C and provided as additional information to the contents ID number to manage and control the contents C. In controlling the distribution of the contents, control of storing and reading the contents C into and from the storage 4 is performed by delivery of the key 50. The management information or control information of the key 50 is sent separately from the key 50 itself.

In the digital contents information distribution system in FIG. 7, conditions for using contents, such as reading the contents C from the storage 4, transferring the read contents, and the like, are determined at the time of distributing the contents. In general, the contents C are distributed through the communication network 2 in many cases. It is assumed that, in such cases, various disruptions of transmission and distribution depending on the characteristics of the network can be encountered in the distribution process. In some cases, part of distribution conditions are altered or lost, thus, contents cannot be distributed according to initially set conditions. In other words, although condition setting for reuse of the contents C depends on the initial setting at the time of distributing the contents C, if the condition setting is changed on purpose, by accident, or the like during distribution, contents distribution which is not intended by the contents right holder or the distributor can be performed. As long as contents distribution which is not intended by the contents right holder or the distributor can be performed, the function of checking distribution is required on the distributing side and the terminal side.

In conventional technology, the methods of embedding set conditions and an ID number directly into contents using digital watermarking or the like and separately distributing a key for decrypting the digital watermark information have been used. Such techniques using the digital watermarking are disclosed in Japanese Laid-open Publications Nos. 2000-155718, 11-179982, and 2001-256192, and U.S. Pat. No. 5,144,665.

However, the conventional contents distribution model in FIG. 7 has following problems. Firstly, the contents distribution apparatus 1 needs to have function of executing an authentication control involving complicated operations, such as digital watermark embedding and key decryption. Further, the quality of the contents (e.g. picture quality and audio quality) can be affected because the digital watermark information is embedded directly in the contents C to be distributed. Furthermore, due to concealment of authentication information, decryption of the information requires such techniques as a highly reliable means of transmitting the information of the key 50, digital watermark signal processing, the function of superimposing the digital watermark information on the contents, and the function of decrypting the concealment control information sent. In addition, if information regarding the distribution conditions of the contents C set at the time of distribution is changed by various alterations and disruptions during distribution, the change cannot be checked directly, and the effect on the quality of the distributed contents C cannot be avoided.

Therefore, it is an object of the present invention to achieve a secure contents distribution and prevention of illegal distribution of the contents without complicated encryption such as digital watermarking. In detail, it is an object of the present invention to achieve prevention of tapping and altering of the contents without complicated encryption such as digital watermarking. Further, it is an object of the present invention to implement the control of reliably tracking or preventing the storing, reuse, and transfer of contents which are not intended by a contents right holder or a contents distributor without complicated encryption such as digital watermarking.

### SUMMARY OF THE INVENTION

A first aspect of the invention provides a contents distribution system for distributing contents from a contents distribution apparatus to a terminal to which a storage is connected, the contents distribution apparatus comprising: a conversion section for converting the contents by a contents identification number previously allocated to the contents, thereby generating converted contents; a composite key generation section for generating a composite key from the contents identification number, a storage identification number previously allocated to the storage, and a terminal key corresponding to the terminal; and a first computing unit for adding the composite key generated by the composite key generation section to the converted contents generated by the conversion section, thereby generating added conversion contents, and the terminal comprising: a terminal key management section for storing the terminal key; a storage identification number memory section for storing the storage identification number; a separator for separating the added conversion contents into the converted contents and the composite key, and storing the converted contents in the storage; a control computing section for calculating the contents identification number from the composite key using the terminal key stored in the terminal key management section and the storage identification number stored in the storage identification number memory section; and a reverse conversion section for executing a conversion process on the converted contents stored in the storage to obtaining the contents, the conversion process being reverse to the conversion process executed by the conversion section of the contents distribution apparatus.

According to the present invention, the converted contents cannot be converted to the original contents if the contents ID number is not added to the contents information distributed from the contents distribution apparatus to the terminal. Further, even if the contents identification number is added to the contents information, the converted contents information cannot be converted correctly to the original contents if correct operations to the contents identification number are not executed by using the terminal number and the storage identification number, that is, if the requested contents information is tapped by a third party.

Preferably, the contents distribution system further comprises a content identification management section for storing the contents identification number so as to be related to the contents. The conversion section of the contents distribution apparatus obtains the contents identification number corresponding to the contents requested by the terminal from the contents identification number management section.

Further, it is preferable that the system comprises a storage identification number management section for storing the storage identification number so as to be related to the storage; and a combined identification number generation section for generating a combined identification number from the contents identification number stored in the contents identification number management section and the storage identification number stored in the storage identification number management section by using a previously determined function according to a request from the contents distribution apparatus. The composite key generation system of the contents distribution apparatus generates the composite key from the combined identification number obtained from the combined identification number generation section and the terminal key.

Furthermore, the control computing section preferably comprises a first divider for calculating the combined identification number from the composite key by using the terminal key stored in the terminal key management section, and a second divider for calculating the contents identification number from the combined identification number calculated by the first divider by using the storage identification number stored in the storage identification number memory section.

It is preferable that the terminal further comprises an adding operation unit for adding at least one of the storage identification number, a terminal number previously allocated to the terminal, and the contents identification number, to the contents obtained by the reverse conversion section, and outputting them. Even if the contents are duplicated or distributed illegally, who has done it is immediately identified. Therefore, illegal distribution of contents can be prevented.

The system preferably comprises a communication network for effecting the interconnection between the contents distribution apparatus and the terminal. The contents distribution apparatus further comprises a first communication section for transmitting the added conversion contents generated by the first computing unit via the communication network. The terminal further comprises a second communication section for receiving the added conversion contents.

A second aspect of the present invention provides a contents distribution apparatus for distributing contents to a terminal to which a storage is connected, comprising: a conversion section for converting the contents by a contents identification number previously allocated to the contents, thereby generating converted contents; a composite key generation section for generating a composite key from the contents identification number, a storage identification number previously allocated to the storage, and a terminal key corresponding to the terminal; a first computing unit for adding the composite key generated by the composite key generation section to the converted contents generated by the conversion section, thereby generating added conversion contents; and an interface section for outputting the added conversion contents to the terminal.

A third aspect of the present invention provides a terminal to which contents from a contents distribution apparatus is distributed and a storage is connected, comprising: an interface section to which added conversion contents is inputted from the contents distribution apparatus; a terminal key management section for storing a terminal key; a storage identification number memory section for storing a storage identification number previously allocated to the storage; a separator for separating the added conversion contents into converted contents and a composite key, and storing the converted contents in the storage; a control computing section for calculating a contents identification number previously allocated to the contents from the composite key using the terminal key stored in the terminal key management section and the storage identification number stored in the storage identification number memory section; and a reverse conversion section for executing a conversion process on the converted contents stored in the storage to obtaining the contents.

A fourth aspect of the present invention provides a method of distributing contents from a contents distribution apparatus to a terminal to which a storage is connected, comprising: converting the contents by a contents identification number previously allocated to the contents, thereby generating converted contents; generating a composite key from a storage identification number previously allocated to the storage and a terminal key allocated to the terminal; adding the composite key to the converted contents, thereby generating added conversion contents; and sending the added conversion contents from the contents distribution apparatus to the terminal.

### BRIEF DESCRIPTION OF THE DRAWINGS

Further objects and advantages of the present invention will become clear from the following description taking in conjunction with the preferred embodiments thereof with reference to the accompanying drawings, in which:

FIG. 1 is a schematic block diagram showing a contents distribution system according to an embodiment of the present invention;

FIG. 2 is a schematic block diagram showing a contents distribution apparatus;

FIG. 3 is a schematic block diagram showing a terminal;

FIG. 4 is a flowchart for explaining an operation of the contents distribution apparatus;

FIG. 5 is a flowchart for explaining an operation of the terminal;

FIG. 6 is a schematic block diagram showing alternative construction of the terminal; and

FIG. 7 is a schematic block diagram showing a conventional contents distribution system.

### PREFERRED EMOBODIMENT OF THE INVENTION

Embodiments of the present invention will described with reference to accompanied drawings.

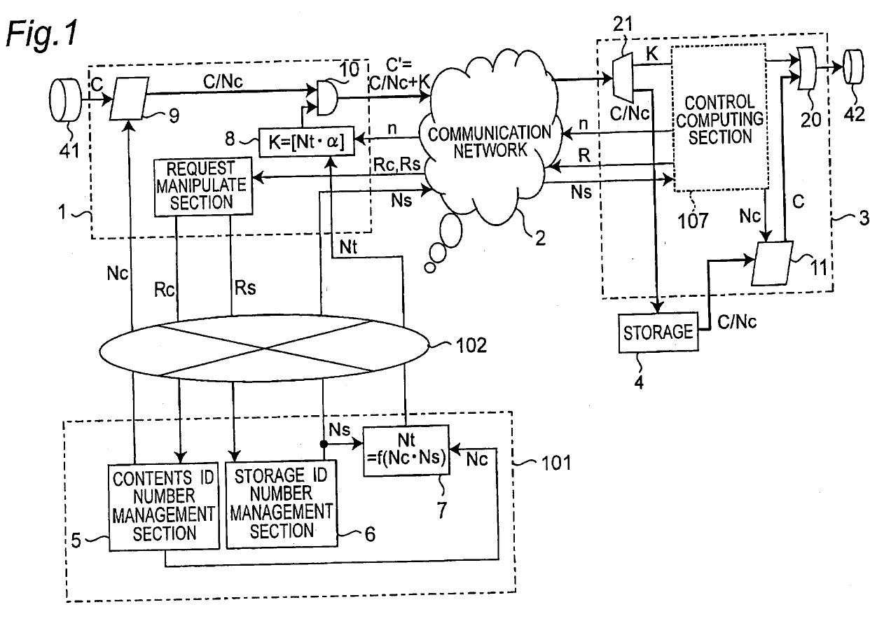

FIG. 1 shows an example of a configuration of a contents distribution system according to the present invention. The configuration of FIG. 1 provides a contents distribution system in which a contents user who owns or uses the a terminal 3 obtains access information required for contents retrieval from contents-related information to obtain and store desired contents. Specifically, the distributed contents are divided contents identification number (contents ID number) previously registered in a registration organization. This allows the contents user to obtain and store contents without permitting a third party to use the contents freely.

Similarly to the contents ID number Nc, for the purpose of storing contents relating to the contents ID number Nc, a storage identification number (storage ID number) Ns is previously obtained by obtaining registered authentication of a storage 4 connected to the terminal 3 from the registration organization.

Both of the contents ID number Nc and the storage ID number Ns are used for an operation using a previously determined function to generate a combined identification number (combined ID number) Nt. The contents distribution apparatus 1 multiplies the combined ID number Nt by a key (terminal key) α allocated to each terminal 3 for composition. Further, the resultant of the operation is added to the converted contents for distribution. Thus, security and reliability can be enhanced.

On the receiving side or the terminal 3, confidentiality and security against a third party are secured by storing the converted contents with maintaining the converted state in the storage 4. There are no specific problems in obtaining and storing contents if the storage ID number Ns has been allocated to the storage 4 and the terminal 3 obtains the terminal key α.

The original contents can be obtained from the above converted contents by a multiplication operation using the contents ID number Nc. In order to obtain the contents ID number Nc on the terminal 3, the combined ID number Nt is firstly obtained by a division operation using the terminal key α. Then, the contents ID number Nc is obtained from the combined ID number Nt by a division operation using the storage ID number Ns. The original contents are obtained from the thus obtained contents ID number Nc by a multiplication operation.

The contents distribution system according to the present invention will be described in detail with reference to FIGS. 1 to 3.

Referring to FIG. 1, in the contents distribution system, contents C are transmitted from an input terminal 41 to an output terminal 42.

In FIG. 1, a reference numeral 1 denotes a contents distribution apparatus, 2 denotes a communication network, 3 denotes a terminal connected to the contents distribution apparatus 1 via the communication network, 4 denotes a storage connected to the terminal 3, and 101 denotes a identification number management apparatus connected to the contents distribution apparatus 1 via a communication line 102 such as a private line. The content distribution apparatus 1 is owned or used by the provider who distributes contents. The terminal 3 is owned or used by contents user. The identification number management apparatus 101 is owned or used by the registration organization. Each of the contents distribution apparatus 1, terminal 3, and identification number management apparatus 101 is constructed by a computer including a CPU, memory, external memory device, input device, and output device, and software installed in the identification number management apparatus 101 and executed by the CPU.

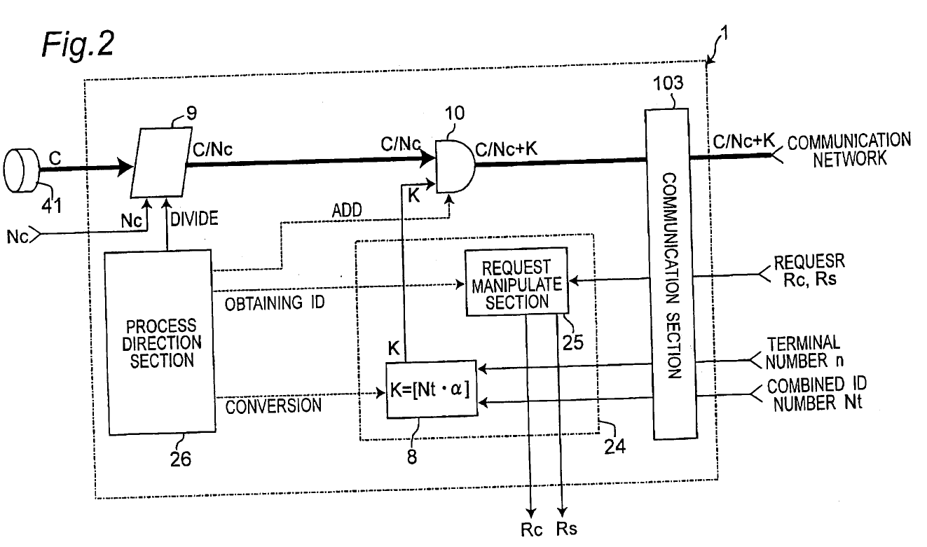

The contents distribution apparatus 1 will be described. Referring to FIGS. 1 and 2, the contents distribution apparatus is provided with a conversion section 9, distribution control section 24 including a composite key generation section 8 and request manipulate section, adder (first computing unit) 10, interface or communication section 10, and process direction section 26.

The conversion section 9 operates (divides) the contents C by the contents ID number Nc to generate converted contents C/Nc. The composite key generation section 8 generates a composite key K from the contents ID number Nc, storage ID number Ns, and terminal key α corresponding to the terminal 3. The composite key K acts as decryption information for the distributed contents C. The adder 10 adds the composite key K to the converted contents C/Nc to generate added conversion contents (C/Nc+K). As described aferward, the request manipulate section 25 separates a signal for requesting contents and transmit the same to the identification number management apparatus 101. The interface or communication section 103 executes transmission and receipt of information to and from the terminal 3. The process direction section 26 commands each system control in the contents distribution apparatus 1.

The identification number management apparatus 101 will be described. Referring to FIG. 1, the identification number management apparatus 101 is provided with a contents identification number management section 5, storage identification number management section 6, and combined ID number generation section 7.

The contents identification number management section 5 contains the contents ID numbers Nc allocated by the registration organization so that each of the contents ID numbers is related to corresponding contents C. Further, responding to a request from the contents distribution apparatus 1, the contents identification number management section 5 transmits the contents ID number corresponding to specific contents C to the contents distribution apparatus 1. The storage identification number management section 6 contains the storage ID numbers Ns allocated by the registration organization so that each of the storage ID numbers Ns is related to corresponding storage 4. Further, responding to the request from the contents distribution apparatus 1, the storage identification number management section 6 transmits the storage ID number Ns corresponding to specific storage 4 to the contents distribution apparatus 1. The combined identification number generation section 7, responding to the request from the contents distribution apparatus 1, generates a combined identification number Nt from the contents ID number Nc and the storage ID number Ns using previously determined function f.

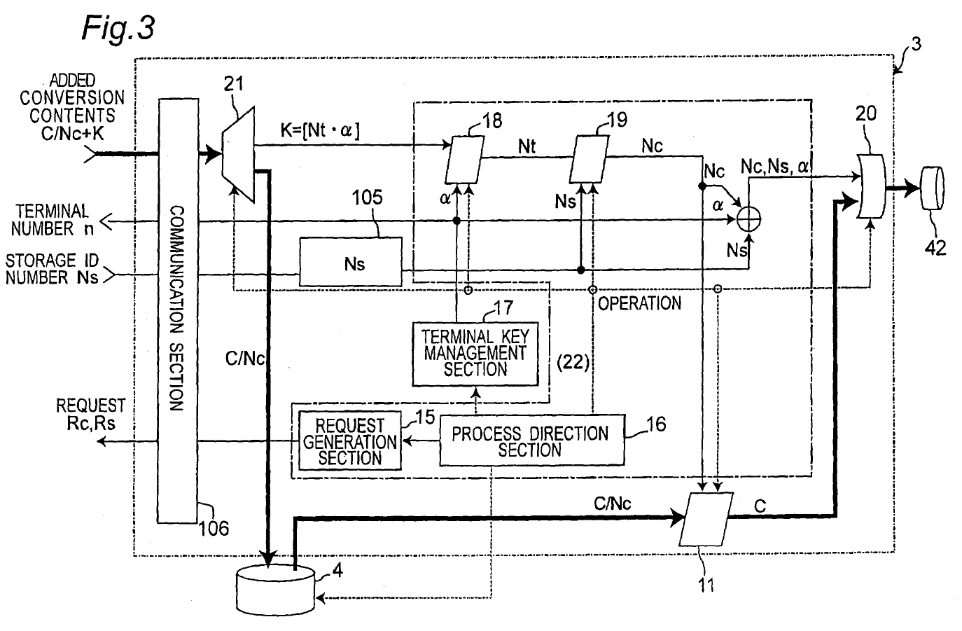

The terminal 3 will be described. Referring to FIGS. 1 and 3, the terminal 3 is provided with a terminal key management section 17 for storing terminal keys α, separator 21, control computing section 107, multiplier (reverse conversion section) 11, adding operation unit 20, and interface or communication section 106.

The separator 21 separates the added conversion contents (C′=C/Nc+K) into the converted contents C/Nc and the composite key K, and stores the converted contents C/Nc in the storage 4.

The control computing section 107 is provide with first and second dividers 18 and 19, a request generation section 15, and process direction section 16. The first divider 18 calculates the combined identification number Nt from the composite key K using the terminal key α. The second divider 19 calculates the contents ID number Nc from the combined ID number Nt using the storage ID number Ns. The request generation section 15 generates a distribution request Rc for the contents C and transmission request Rs for the storage ID number Ns. The process direction section 16 commands process of each system control in the terminal 3.

The multiplier 11 multiplies the contents ID number Nc calculated by the control computing operation section 107 with the converted contents C/Nc stored in the storage 4, thereby calculating the contents C. As described afterward, the adding operation unit 20 adds contents ID number Nc and the like to the contents C calculated by the multiplier 11 and outputs them to the output terminal 42.

The terminal key α will be described. The terminal key α according to the terminal number n of the terminal 3 is allocated by the contents distributor. The contents user obtains the terminal key α by means of an IC card or download. The obtained terminal key α is stored in the terminal key management section 17 of the terminal 3. The terminal key α is also stored in the terminal key generation section 8 of the contents distribution apparatus so as to be related to the terminal number n.

The storage 4 is constituted such device as a hard disk, SD card, or a DVD-RAM. A type of the storage 4 is not limited as long as it can contain the contents information.

Then, an operation of the contents distribution system will be described. A transmission request Rs generated by the request generation section 15 of the terminal 3 is sent to the contents distribution apparatus 1 via the communication network 2. The transmission request Rs is sent the identification number management apparatus 101 via the request manipulate section 25 and the communication line 102. The storage identification number management section 6 transmits the storage ID number Ns corresponding to the storage 4 connected to the terminal 3 to the contents distribution apparatus 1 via the communication line 102. Then, the contents distribution apparatus 1 transmits the storage ID number Ns to the terminal 3. The storage ID number Ns received by the terminal 3 is stored in the storage identification number memory section 105.

Then, an operation executed when a contents transmission request Rc is transmitted to the contents distribution apparatus 1 will be described. In the following descriptions, the contents C, contents ID number Nc, and composite Key K is represented as shown in following equations (1) as occasion requires.

$$\begin{matrix}C = [ \begin{matrix}1 & 0 & 1 \\ 0 & 1 & 1 \\ 0 & 0 & 1\end{matrix} ] \\ {N}_{c} = [ \begin{matrix}1 , & 1 , & 0\end{matrix} ] \\ K = [ \begin{matrix}0 , & 1 , & 0\end{matrix} ]\end{matrix} \qquad ( 1 )$$

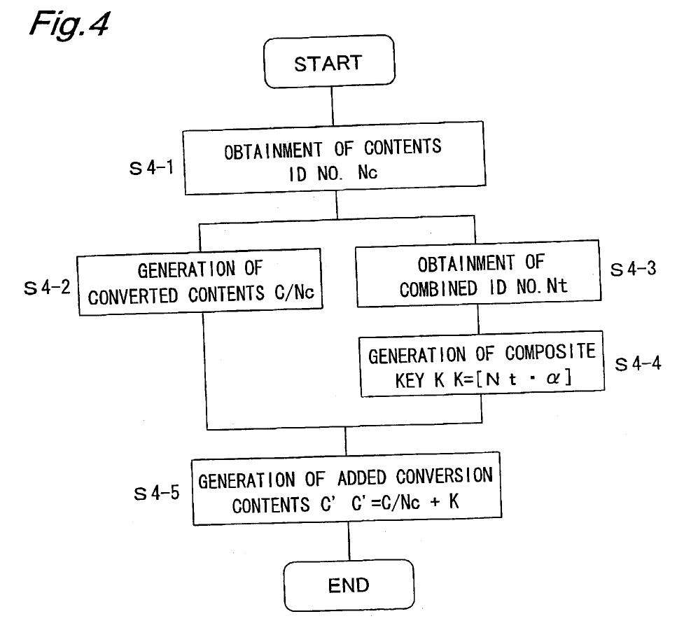

When the contents transmission is requested, a contents transmission request Rc and the terminal number n is transmitted from the terminal 3 to the contents distribution apparatus 1. The contents distribution request Rc includes information for identifying the contents C, e.g. a title of the contents. Referring to FIG. 4, the contents distribution apparatus 1 that has received the contents transmission request Rc obtains corresponding contents ID number Nc from the contents identification number management section 5 (Step S4-1). Specifically, the contents distribution request Rc is inputted in the contents identification number management section 5 via the request manipulate section 25 and communication line 102, and then the contents identification number management section 5 transmits the contents ID number Nc to the contents distribution apparatus 1. Then, the contents ID number Nc is inputted to the conversion section 9. The conversion section 9 executes an operation for dividing by the contents C the inputted contents ID number Nc, thereby generating the converted contents C/Nc (Step S4-2 and following equation (2)).

$$\begin{matrix}C / {N}_{c} = [ \begin{matrix}1 & 0 & 1 \\ 0 & 1 & 1 \\ 0 & 0 & 1\end{matrix} ] \div [ \begin{matrix}1 , & 1 , & 0\end{matrix} ] \\ = [ \begin{matrix}0 & 1 & 1 \\ 1 & 0 & 1 \\ 1 & 1 & 1\end{matrix} ]\end{matrix} \qquad ( 2 )$$

On the other hand, when the identification number management apparatus 101 receives the contents distribution request Rc, the contents ID number Nc is inputted from the contents identification number management section 5 for the combined contents number generation section 7. Further, the combined identification number generation section7 generates the combined identification number Nt from the contents ID number Nc and storage ID number Ns using the predetermined function f. The contents distribution apparatus 1 obtains the combined ID number Nt from the combined identification number generation section 7 (Step S4-3). In detail, the combined ID number Nt is inputted to the composite key generation section 8.

Then, the composite key generation section 8 generates the composite Key K (Step S4-4). Specifically, the composite key generation section 8 executes an operation for multiplying the combined ID number N by the terminal key a corresponding the terminal number n received from the terminal, thereby generating the composite key K.

Then, the adder 10 generates the added conversion contents C′ (Step S 4-5 and following equation (3)). Specifically, the converted contents C/Nc is inputted from the conversion section 9 to the adder 10 as well as the composite key K is inputted from the composite key generation section 8 to the adder 10. The adder adds the composite key K to the converted contents C/Nc, thereby generating the added conversion contents C′.

$$\begin{matrix}{C}^{′} = C / {N}_{c} + K \\ = [ \begin{matrix}0 & 1 & 1 \\ 1 & 0 & 1 \\ 1 & 1 & 1\end{matrix} ] + [ 0 , 1 , 0 ] \\ = [ \begin{matrix}0 & 1 & 1 \\ 1 & 0 & 1 \\ 1 & 1 & 1 \\ 0 & 1 & 0\end{matrix} ]\end{matrix} \qquad ( 3 )$$

The contents distribution apparatus 1 transmits the converted conversion contents C′ to the terminal 3 via the communication network 2.

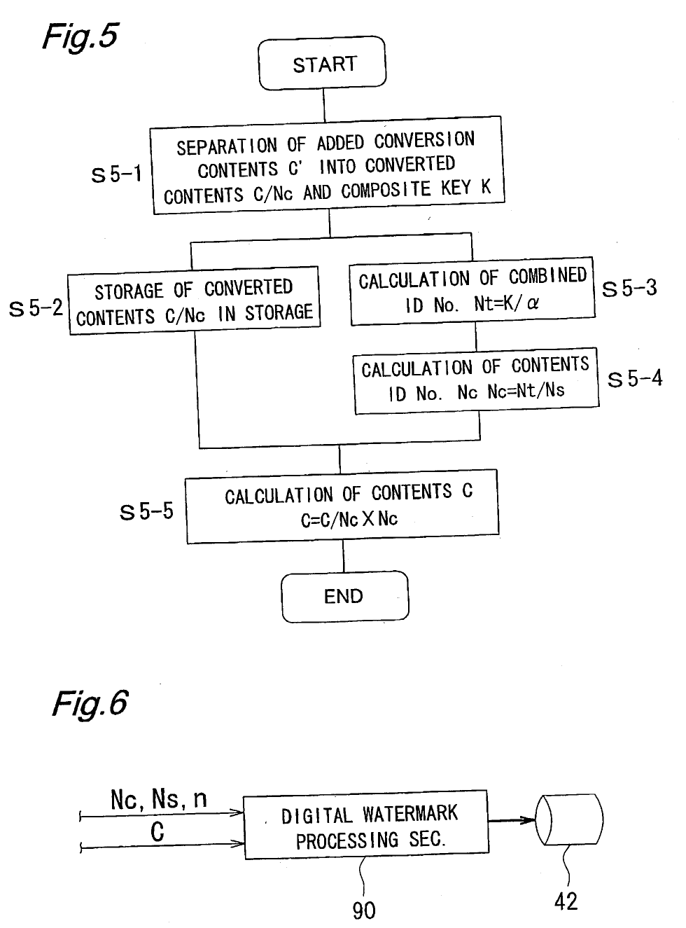

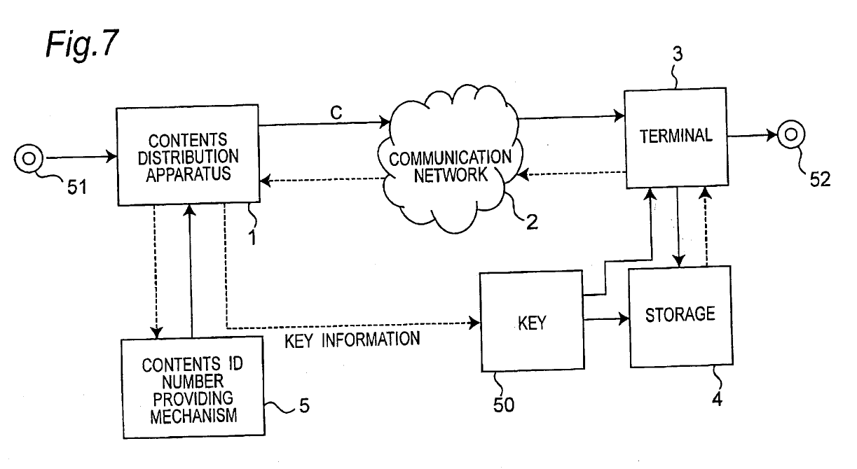

The added conversion contents C′ received by the terminal 3 is inputted to the separator 21. Referring to FIG. 5, the separator 21 separates the added conversion contents C′ into the converted contents C/Nc and the composite key K (Step S5-1 and following equation (4)).

$$\begin{matrix}C / {N}_{c} = {C}^{′} - K \\ = [ \begin{matrix}0 & 1 & 1 \\ 1 & 0 & 1 \\ 1 & 1 & 1 \\ 0 & 1 & 0\end{matrix} ] - [ 0 , 1 , 0 ] \\ = [ \begin{matrix}0 & 1 & 1 \\ 1 & 0 & 1 \\ 1 & 1 & 1\end{matrix} ]\end{matrix} \qquad ( 4 )$$

The converted contents C/Nc is stored in the storage 4. In other wards, the contents stored in the storage 4 is the contents obtained by the operation using the contents ID number Nc, i.e. the converted contents C/Nc. If the converted contents C/Nc are read out without being converted, they are mere nothing but signals without meaning. Therefore, even if the contents are read out without a proper authorization, the contents are mere signals that make no value, achieving a protection of the contents.

On the other hand, the composite key K is inputted to the first divider 18. The first divider 18 executes an operation for dividing the composite key K by the terminal key α stored in the terminal key management section 17, thereby generating the combined ID number Nt (Step S5-3). The calculated combined ID number Nt is inputted to the second divider 19. The second divider 19 executes an operation for dividing the combined ID number Nt by the storage ID number Ns stored in the storage identification memory section 105, thereby calculating the contents ID number Nc (Step S5-4). The calculated contents ID number Nc is inputted to the multiplier 11. The multiplier 11 executes an operation for multiplying the converted contents C/Nc stored in the storage by the contents ID number Nc, thereby calculating the contents C (Step S5-5 and equation (5)).

$$\begin{matrix}C / {N}_{c} \times {N}_{c} = [ \begin{matrix}0 & 1 & 1 \\ 1 & 0 & 1 \\ 1 & 1 & 1\end{matrix} ] \times [ \begin{matrix}1 , & 1 , & 0\end{matrix} ] \\ = [ \begin{matrix}1 & 0 & 1 \\ 0 & 1 & 1 \\ 0 & 0 & 1\end{matrix} ]\end{matrix} \qquad ( 5 )$$

The contents C calculated by the multiplier 11 is outputted to the adding operation unit 20. The adding operation unit 20, as occasion arises, adds one(s) of the contents ID number Nc, storage ID number Ns, and terminal number n to the contents C so as to output them to the output terminal 42. Further, as occasion arises, the adding operation unit 20 can add a code for prohibiting duplication of the contents and the like.

As shown in FIG. 6, as a substitution for the adding operation unit 20, a digital watermarking processing section 90 can be provided so as to embed one(s) of the contents ID number Nc, storage ID number Ns, and terminal number n in the contents C.

The contents identification number management section 5, storage identification number management section 6, and the combined identification number generation section 7 can be constituted as other apparatuses from each other. The present invention can be adapted to other contents distribution in which the contents are not distributed via the communication network e.g. contents distribution using a medium for storing the contents such as a DVD.

According to the present invention, the contents distribution apparatus adds the composite key, which is generated by the composite key generation section from the contents identification number, storage identification, and the terminal key, to the conversion contents generated by the conversion section, thereby generating the added conversion contents. The added conversion contents received by terminal is separated into the composite key and converted contents, followed by storing the converted contents to the storage. Accordingly, the converted contents cannot be converted to the original contents if the contents ID number is not added to the contents information distributed from the contents distribution apparatus to the terminal. Further, even if the contents ID number is added to the contents information, the converted contents information cannot be converted correctly to the original contents if correct operations to the contents identification number are not executed by using the terminal number and the storage identification number, that is, if the requested contents information is tapped by a third party. These achieve a secure contents distribution.

The adding operation unit of the terminal adds at least one of the storage identification number, a terminal number previously allocated to the terminal, and the contents identification number, to the contents, and outputs them. Therefore, even if the contents are duplicated or distributed illegally, who has done it is immediately identified. Thus, illegal distribution of contents can be prevented. This achieves prevention of the illegal distribution on the contents.

Although the present invention has been fully described by way of the examples with reference to the accompanying drawings, it is to be noted here that various changes and modifications will be apparent to those who skilled in the art. Therefore, unless such changes and modifications otherwise depart from the spirit and scope of the present invention, they should be construed as being therein.

The present disclosure relates to subject matter contained in priority Japanese Patent Application No. 2002-161455, filed on Jun. 3, 2002, the contents of which is herein expressly incorporated by reference in its entirety.

What is claimed is:

1. A contents distribution system for distributing contents from a contents distribution apparatus to a terminal to which a storage is connected,
the contents distribution apparatus comprising:
a conversion section for converting the contents by a contents identification number previously allocated to the contents, thereby generating converted contents;
a composite key generation section for generating a composite key from the contents identification number, a storage identification number previously allocated to the storage, and a terminal key corresponding to the terminal; and
a first computing unit for adding the composite key generated by the composite key generation section to the converted contents generated by the conversion section, thereby generating added conversion contents, and
the terminal comprising:
a terminal key management section for storing the terminal key;
a storage identification number memory section for storing the storage identification number;
a separator for separating the added conversion contents into the converted contents and the composite key, and storing the converted contents in the storage;
a control computing section for calculating the contents identification number from the composite key using the terminal key stored in the terminal key management section and the storage identification number stored in the storage identification number memory section; and
a reverse conversion section for executing a conversion process on the converted contents stored in the storage to obtaining the contents, the conversion process being reverse to the conversion process executed by the conversion section of the contents distribution apparatus.

2. A contents distribution system according to claim 1, further comprising, a content identification management section for storing the contents identification number so as to be related to the contents,
wherein the conversion section of the contents distribution apparatus obtains the contents identification number corresponding to the contents requested by the terminal from the contents identification number management section.

3. A contents distribution system according to claim 2, further comprising:
a storage identification number management section for storing the storage identification number so as to be related to the storage; and
a combined identification number generation section for generating a combined identification number from the contents identification number stored in the contents identification number management section and the storage identification number stored in the storage identification number management section by using a previously determined function according to a request from the contents distribution apparatus,
wherein the composite key generation system of the contents distribution apparatus generates the composite key from the combined identification number obtained from the combined identification number generation section and the terminal key.

4. A contents distribution system according to claim 1, wherein the control computing section comprises:
a first divider for calculating the combined identification number from the composite key by using the terminal key stored in the terminal key management section; and
a second divider for calculating the contents identification number from the combined identification number calculated by the first divider by using the storage identification number stored in the storage identification number memory section.

5. A contents distribution system according to claim 1, wherein the terminal further comprises an adding operation unit for adding at least one of the storage identification number, a terminal number previously allocated to the terminal, and the contents identification number, to the contents obtained by the reverse conversion section, and outputting them.

6. A contents distribution system according to claim 1, further comprising a communication network for effecting the interconnection between the contents distribution apparatus and the terminal,
wherein the contents distribution apparatus further comprises a first communication section for transmitting the added conversion contents generated by the first computing unit via the communication network, and
wherein the terminal further comprises a second communication section for receiving the added conversion contents.

7. A contents distribution apparatus for distributing contents to a terminal to which a storage is connected, comprising:
a conversion section for converting the contents by a contents identification number previously allocated to the contents, thereby generating converted contents;
a composite key generation section for generating a composite key from the contents identification number, a storage identification number previously allocated to the storage, and a terminal key corresponding to the terminal;
a first computing unit for adding the composite key generated by the composite key generation section to the converted contents generated by the conversion section, thereby generating added conversion contents; and
an interface section for outputting the added conversion contents to the terminal.

8. A contents distribution apparatus according to claim 7, wherein the contents distribution apparatus is connected to a contents identification management section for storing the contents identification number so as to be related to the contents, and
wherein the conversion section obtains the contents identification number corresponding to the contents requested by the terminal from the contents identification number management section.

9. A contents distribution apparatus according to claim 8, wherein the contents distribution apparatus is connected to a storage identification number management section for storing the storage identification number so as to be related to the storage,
wherein the contents distribution apparatus is connected to a combined identification number generation section for generating a combined identification number from the contents identification number stored in the contents identification number management section and the storage identification number stored in the storage identification number management section by using a previously determined function according to a request from the contents distribution apparatus, and
wherein the composite key generation section generates the composite key from the combined identification number obtained from the combined identification number generation section and the terminal key.

10. A contents distribution apparatus according to claim 7, wherein the interface section transmits the added conversion contents generated by the first computing unit to the terminal through a communication network.

11. A terminal to which contents from a contents distribution apparatus is distributed and a storage is connected, comprising:
an interface section to which added conversion contents is inputted from the contents distribution apparatus;
a terminal key management section for storing a terminal key;
a storage identification number memory section for storing a storage identification number previously allocated to the storage;
a separator for separating the added conversion contents into converted contents and a composite key, and storing the converted contents in the storage;
a control computing section for calculating a contents identification number previously allocated to the contents from the composite key using the terminal key stored in the terminal key management section and the storage identification number stored in the storage identification number memory section; and
a reverse conversion section for executing a conversion process on the converted contents stored in the storage to obtaining the contents.

12. A terminal according to claim 11, wherein the control computing section further comprises:
a first divider for calculating the combined identification number from the composite key by using the terminal key stored in the terminal key management section; and
a second divider for calculating the contents identification number from the combined identification number calculated by the first divider by using the storage identification number stored in the storage identification number memory section.

13. A terminal according to claim 11, further comprising a adding operation unit for adding at least one of the storage identification number, a terminal number previously allocated to the terminal, and the contents identification number, to the contents, and outputting them.

14. A method of distributing contents from a contents distribution apparatus to a terminal to which a storage is connected, comprising:
converting the contents by a contents identification number previously allocated to the contents, thereby generating converted contents;
generating a composite key from a storage identification number previously allocated to the storage and a terminal key allocated to the terminal;
adding the composite key to the converted contents, thereby generating added conversion contents; and
sending the added conversion contents from the contents distribution apparatus to the terminal.

15. A method of distributing contents according to claim 14, further comprising:
separating the added conversion contents transmitted from the contents distribution apparatus to the terminal into the converted contents and the composite key;
storing the converted contents in the storage;
calculating the contents identification number from the composite key by using the terminal key and the storage identification number; and
executing a conversion process on the converted contents stored in the storage by using the contents identification number, thereby obtaining the contents.

16. A method of distributing contents according to claim 15, further comprising, adding at least one of the storage identification number, a terminal number previously allocated to the terminal, and the contents identification number, to the obtained contents, and outputting them.
